(19) United States
(12) Patent Application Publication
(10) Pub. No.: US 2004/0024590 A1
(43) Pub. Date: Feb. 5, 2004

(54) Apparatus and method for determining correlation coefficient between signals, and apparatus and method for determining signal pitch therefor

(75) Inventor: Geon-Hyoung Lee, Hwaseong-gun (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/618,741

(22) Filed: Jul. 15, 2003

(30) Foreign Application Priority Data
Aug. 1, 2002 (KR) 2002-45567

(51) Int. Cl. G10L 11/04

(52) U.S. Cl. 704/207

(57) ABSTRACT

An apparatus and method for determining a correlation coefficient between signals and determining a signal pitch. An operation unit receives a sampled signal x[i+k] and a signal y[j+k] (k is an integer from 0 to M−1), applies those signals to a first membership function of a first fuzzy set having large values, obtains a minimum value, obtains a probability P1 that the signals have large values, applies the signals to a second membership function of a second fuzzy set having small values, obtains a minimum value, obtains a probability P2 that the signals have small values, obtains a maximum value between P1 and P2, obtains a probability P3 that the signals have large or small values, increases k, repeats the above operations for each k, and obtains M probabilities P3. An addition unit obtains a correlation coefficient indicating a degree of similarity between the signals by adding M probabilities P3.

### BACKGROUND OF THE INVENTION

This application claims the priority of Korean Patent Application No. 2002-45567, filed on Aug. 1, 2002, in the Korean Intellectual Property Office, the disclosure of which is incorporated herein in its entirety by reference.

1. Field of the Invention

The present invention relates to an apparatus and method for determining a correlation coefficient which indicates a degree of similarity between signals, and an apparatus and method for determining a signal pitch therefor.

2. Description of the Related Art

A speech signal is a characteristic in which a similar signal is continuously repeated. A period after which the similar signal is repeated is referred to as a pitch. An example of a pitch of a speech signal is shown in FIG. 1.

In the fields of speech encoders, speech recognition, and speech synthesis, an algorithm for obtaining a pitch is needed to encode and/or decode a speech signal. In general, algorithms for obtaining a pitch are based on the assumption that a speech signal is similar to a speech signal before one pitch. As such, according to G.723.1 and G.729 standards developed by the International Telecommunication Union (ITU) and GSM Europe, a pitch is obtained when a strong correlation exists between a speech signal after one pitch, and a speech signal before one pitch.

The related art has various problems and disadvantages. For example, but not by way of limitation, to obtain a pitch using a related art method, a large number of multiplication operations must be performed so that the computational time for obtaining a pitch takes about 25% of the entire encoding computational time. In addition, many logic devices are required to design and process a related art algorithm for obtaining a pitch using an ASIC. Accordingly, power consumption increases. In particular, in a mobile environment, a technique for reducing the computational time for encoding a speech signal without lowering sound quality is desired.

### SUMMARY OF THE INVENTION

The present invention provides an apparatus and method for determining a correlation coefficient between signals which, by obtaining a correlation coefficient indicating a degree of similarity between two signals using fuzzy logic, increases computation speed and the accuracy of computation, simplifies the structure of the apparatus, and reduces power consumption.

The present invention also provides an apparatus and method for determining a signal pitch which, by obtaining a signal pitch using the apparatus and method for determining a correlation coefficient between signals, increases computation speed and the accuracy of computation, simplifies the structure of the apparatus, and reduces power consumption.

A method for determining a signal pitch is provided, including (a) applying a first signal x[i+k] and a second signal x[i−L+k] where k is an integer from 0 to M−1, corresponding to a signal before a sample L of the first signal x[i+k] to a first membership function μL that is a membership function of a first fuzzy set including large values, obtaining a minimum value therebetween, and obtaining a probability (P1) that the first signal x[i+k] and the second signal x[i−L+k] have large values for 0<=k<=(M−1); (b) applying the first signal x[i+k] and the second signal x[i−L+k] to a second membership function μs, which is a membership function of a second fuzzy set including small values, obtaining a minimum value therebetween, and obtaining a probability (P2) that the first signal x[i+k] and the second signal x[i−L+k] have small values for 0<=k<=(M−1); (c) obtaining a maximum value between the probability P1 and the probability (P2), and generating a probability (P3) that the first signal x[i+k] and the second signal x[i−L+k] have the large values or the small values; (d) increasing the k in units of integers from 0 to M−1, repeating (a) through (c), and obtaining M the probabilities P3; (e) obtaining a correlation coefficient indicating a degree of similarity between the first signal x[i+k] and the second signal x[i−L+k] by adding the M the probabilities P3; (f) varying the sample L in a range, and repeating (a) through (e); and (g) determining the sample L corresponding to a maximum value among a plurality of the correlation coefficients obtained in (e) as a pitch of the first signal x[i+k].

Additionally, a method for determining a signal pitch is provided, including: (a) applying a first signal x[i+k] and a second signal x[i−L+k] for a sample L to the following equation and obtaining a probability P3 that the first signal x[i+k] and the second signal x[i−L+k] have large values or small values:

max[min(μ_{L}(x[i+k]), μL(x[i−L+k])), min(μₛ(x[i+k], μₛ(x[i−L+k]))],

where k is an integer from 0 to M−1, the μL is a first membership function that is a membership function of a first fuzzy set having the large values, and the μs is a second membership function that is a membership function of a second fuzzy set having the small values; (b) increasing the k in units of integers from 0 to M−1, repeating (a), and obtaining M the probabilities P3; (c) obtaining a correlation coefficient indicating a degree of similarity between the first signal x[i+k] and the second signal x[i−L+k] by adding the M probabilities P3; (d) varying the sample L in a predetermined range and repeating (a) through (c); and (e) determining the sample L corresponding to a maximum value among a plurality of correlation coefficients obtained in (c) as a pitch of the first signal x[i+k].

Further, a method for determining a correlation coefficient between signals, including: (a) applying a first signal x[i+k] and a second signal y[j+k], where k is an integer from 0 to M−1, to a first membership function μL of a first fuzzy set having large values, obtaining a minimum value therebetween, and obtaining a probability P1 that the first signal x[i+k] and the second signal y[j+k] have the large values for 0<=k<=(M−1); (b) applying the first signal x[i+k] and the second signal y[j+k] to a second membership function μs of a second fuzzy set having small values, obtaining a minimum value therebetween, and obtaining a probability P2 that the first signal x[i+k] and the second signal y[j+k] have the small values for 0<=k<=(M−1); (c) obtaining a maximum value between the probability P1 and the probability P2 and obtaining a probability P3 that the first signal x[i+k] and the second signal y[j+k] have the large values or the small values; (d) increasing the k in units of integers from 0 to M−1, repeating (a) through (c), and obtaining M probabilities P3; and (e) obtaining a correlation coefficient indicating a degree of similarity between the first signal x[i+k] and the second signal y[j+k] by adding the M probabilities P3 for 0<=k<=(M−1).

Also, a method for determining a correlation coefficient between signals is provided, including: (a) applying a first signal x[i+k] and a second signal y[j+k] to the following equation and obtaining a probability P3 that the first signal x[i+k] and the second signal y[j+k] have large values or small values:

max[min(μ_{L}(x[i+k]), μL(y[j+k])), min(μₛ(x[i+k], μₛ(y[j+k]))],

where k is an integer from 0 to M−1, the μL is a first membership function that is a membership function of a first fuzzy set having the large values, and the μs is a second membership function that is a membership function of a second fuzzy set having the small values; (b) increasing the k in units of integers from 0 to M−1, repeating (a), and obtaining M probabilities P3; and (c) obtaining a correlation coefficient indicating a degree of similarity between the first signal x[i+k] and the second signal y[j+k] by adding the M probabilities P3.

In addition, an apparatus for determining a signal pitch is provided, including an operation unit which receives a first signal x[i+k] and a second signal x[i−L+k] where k is an integer from 0 to M−1, the second signal x[i−L+k] corresponding to a signal before a sample L of the first signal x[i+k], applies the first signal x[i+k] and the second signal x[i−L+k] to a first membership function μL of a first fuzzy set having large values, obtains a minimum value therebetween, and obtaining a probability P1 that the first signal x[i+k] and the second signal x[i−L+k] have large values, applies the first signal x[i+k] and the second signal x[i−L+k] to a second membership function μs of a second fuzzy set having small values, obtains a minimum value therebetween, obtains a probability P2 that the first signal x[i+k] and the second signal x[i−L+k] have small values, obtains a maximum value between the probability P1 and the probability P2, obtains a probability P3 that the first signal x[i+k] and the second signal x[i−L+k] have the large values or the small values, increases the k in units of integers from 0 to M−1, repeats the above operations on a pair of the first signal x[i+k] and the second signal x[i−L+k] corresponding to the k, and obtains M probabilities P3. The apparatus also comprises an addition unit that obtains a correlation coefficient indicating a degree of similarity between the first signal x[i+k] and the second signal x[i−L+k] by adding the M probabilities P3; wherein as the sample L is varied in a range, the operation unit determines the probabilities P3 for each value of the sample L and outputs a result of the determination to the addition unit, and the addition unit determines a correlation coefficient by adding the M probabilities P3 for each value of the sample L and outputs a plurality of correlation coefficients; and a pitch determination unit that determines the sample L corresponding to a maximum value among the plurality of correlation coefficients input from the addition unit as a pitch of the first signal x[i+k].

Also, an apparatus for determining a signal pitch is provided including an operation unit which receives a first signal x[i+k] and a second signal x[i−L+k] where k is an integer from 0 to M−1, the second signal x[i−L+k] corresponding to a signal before a sample L of the first signal x[i+k], applies the first signal x[i+k] and the second signal x[i-L+k] to the following equation:

max[min(μ_{L}(x[i+k]), μ_{L}(x[i−L+k])), min(μₛ(x[i+k], μₛ(x[i−L+k]))]

where the μL is a first membership function of a first fuzzy set having large values, and the μs is a second membership function of a second fuzzy set having small values, wherein the operation unit obtains a probability P3 that all of the first signal x[i+k] and the second signal x[i−L+k] have the large values or the small values, increases the k in units of integers from 0 to M−1, repeats the above operations on a pair of the first signal x[i+k] and the second signal x[i−L+k] corresponding to the k, and obtains M probabilities P3. Additionally, an addition unit is provided that obtains a correlation coefficient indicating a degree of similarity between the first signal x[i+k] and the second signal x[i−L+k] by adding the M probabilities P3 input from the operation unit; wherein as the sample L is varied in a predetermined range, the operation unit determines the probabilities P3 for each value of the sample L and outputs the result of the determination to the addition unit, and the addition unit determines a correlation coefficient by adding the M probabilities P3 for each value of the sample L and outputs a plurality of correlation coefficients; and a pitch determination unit determines the sample L corresponding to a maximum value among the plurality of correlation coefficients input from the addition unit as a pitch of the first signal x[i+k].

Further, an apparatus for determining a correlation coefficient between signals, including: an operation unit that receives a first signal x[i+k] and a second signal y[j+k], where k is an integer from 0 to M−1, applies the first signal x[i+k] and the second signal y[j+k] to a first membership function μL of a first fuzzy set having large values, obtains a minimum value therebetween, obtains a probability P1 that the first signal x[i+k] and the second signal y[j+k] have large values, applies the first signal x[i+k] and the second signal y[j+k] to a second membership function μs of a second fuzzy set having small values, obtains a minimum value therebetween, obtains a probability P2 that the first signal x[i+k] and the second signal y[j+k] have small values, obtains a maximum value between the probability P1 and the probability P2, obtains a probability P3 that the first signal x[i+k] and the second signal y[j+k] have the large values or the small values, increases the k in units of integers from 0 to M−1, repeats the above operations on the first signal x[i+k] and the second signal y[j+k] corresponding to the k, and obtains M probabilities P3; and an addition unit that obtains a correlation coefficient indicating a degree of similarity between the first signal x[i+k] and the second signal y[j+k] by adding the M probabilities P3 input from the operation unit.

An apparatus for determining a correlation coefficient between signals is also provided, including an operation unit which receives a first signal x[i+k] and a second signal y[j+k] where k is an integer from 0 to M−1, applies the first signal x[i+k] and the second signal y[j+k] to the following equation:

max[min(μ_{L}(x[i+k]), μ_{L}(y[j+k])), min(μₛ(x[i+k], μₛ(y[j+k]))]

where the μL is a first membership function of a first fuzzy set having large values, and the μs is a second membership function of a second fuzzy set having small values, obtains a probability P3 that the first signal x[i+k] and the second signal y[j+k] have large or small values, increases the k in units of integers from 0 to M−1, repeats the above operations on a pair of the first signal x[i+k] and the second signal y[j+k] corresponding to the k, and obtains M probabilities P3; and an addition unit that obtains a correlation coefficient indicating a degree of similarity between the first signal x[i+k] and the second signal y[j+k] by adding the M probabilities P3.

In addition to the foregoing, a computer readable recording medium is provided, on which a program for implementing a method for determining a signal pitch is recorded, the program having instructions including: (a) applying a first signal x[i+k] and a second signal x[i−L+k], where k is an integer from 0 to M−1, the second signal x[i−L+k] corresponding to a signal before a sample L of the first signal x[i+k], to a first membership function μL of a first fuzzy set having large values, obtaining a minimum value therebetween, and obtaining a probability P1 that the first signal x[i+k] and the second signal x[i−L+k] have the large values; (b) applying the first signal x[i+k] and the second signal x[i-L+k] to a second membership function μs of a second fuzzy set having small values, obtaining a minimum value therebetween, and obtaining a probability P2 that all of the first signal x[i+k] and the second signal x[i−L+k] have the small values; (c) obtaining a maximum value between the probability P1 and the probability P2 and obtaining a probability P3 that the first signal x[i+k] and the second signal x[i−L+k] have the large values or the small values; (d) increasing the k in units of integers from 0 to M−1, repeating (a) through (c), and obtaining M probabilities P3; (e) obtaining a correlation coefficient indicating a degree of similarity between the first signal x[i+k] and the second signal x[i−L+k] by adding the M probabilities P3; (f) varying the sample L in a predetermined range and repeating (a) through (e); and (g) determining the sample L corresponding to a maximum value among a plurality of correlation coefficients obtained in (e) as a pitch of the first signal x[i+k].

Further, a computer readable recording medium on which a program for implementing a method for determining a signal pitch is recorded, the program having instructions including: (a) applying a first signal x[i+k] and a second signal x[i−L+k] to the following equation and obtaining a probability P3 that the first signal x[i+k] and the second signal x[i−L+k] have large values or small values:

max[min(μ_{L}(x[i+k]), μ_{L}(x[i−L+k])), min(μₛ(x[i+k], μₛ(x[i−L+k]))]

where k is an integer from 0 to M−1, the μL is a first membership function of a first fuzzy set having large values, and the μs is a second membership function of a second fuzzy set having small values; (b) increasing the k in units of integers from 0 to M−1, repeating (a), and obtaining M probabilities P3; (c) obtaining a correlation coefficient indicating a degree of similarity between the first signal x[i+k] and the second signal x[i−L+k] by adding the M probabilities P3; (d) varying the sample L in a predetermined range and repeating (a) through (c); and (e) determining the sample L corresponding to a maximum value among a plurality of correlation coefficients obtained in (c) as a pitch of the first signal x[i+k].

Also, a computer readable recording medium on which a program for implementing a method for determining a correlation coefficient between signals is recorded, the program having instructions including (a) applying a first signal x[i+k] and a second signal y[j+k], where k is an integer from 0 to M−1, to a first membership function μL of a first fuzzy set having large values, obtaining a minimum value therebetween, and obtaining a probability P1 that the first signal x[i+k] and the second signal y[j+k] have the large values; (b) applying the first signal x[i+k] and the second signal y[j+k] to a second membership function μs of a second fuzzy set having small values, obtaining a minimum value therebetween, and obtaining a probability P2 that the first signal x[i+k] and the second signal y[j+k] have the small values; (c) obtaining a maximum value between the probability P1 and the probability P2 and obtaining a probability P3 that the first signal x[i+k] and the second signal y[j+k] have the large values or the small values; (d) increasing the k in units of integers from 0 to M−1, repeating (a) through (c), and obtaining M probabilities P3; and (e) obtaining a correlation coefficient indicating a degree of similarity between the first signal x[i+k] and the second signal y[j+k] by adding the M probabilities P3.

Additionally, a computer readable recording medium on which a program for implementing a method for determining a correlation coefficient between signals is recorded, the program having instructions including: (a) applying a first signal x[i+k] and a second signal y[j+k] to the following equation and obtaining a probability P3 that the first signal x[i+k] and the second signal y[j+k] have large values or small values:

max[min(μ_{L}(x[i+k]), μ_{L}(y[j+k])), min(μₛ(x[i+k], μₛ(y[j+k]))]

where k is an integer from 0 to M−1, the μL is a first membership function of a first fuzzy set having large values, and the μs is a second membership function of a second fuzzy set having small values; (b) increasing the k in units of integers from 0 to M−1, repeating (a), and obtaining M probabilities P3; and (c) obtaining a correlation coefficient indicating a degree of similarity between the first signal x[i+k] and the second signal y[j+k] by adding the M probabilities P3.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a pitch of a related art speech signal;

FIGS. 2A and 2B are examples of membership functions of a fuzzy set;

FIG. 3 is a block diagram illustrating an embodiment of an apparatus for determining a correlation coefficient between signals according to an exemplary, non-limiting embodiment of the present invention;

FIG. 4 is a block diagram illustrating an example of an operation unit shown in FIG. 3 according to an exemplary, non-limiting embodiment of the present invention;

FIG. 5 is a block diagram illustrating an example of an operation unit shown in FIG. 3 according to an exemplary, non-limiting embodiment of the present invention;

FIG. 6 is a block diagram illustrating an embodiment of an apparatus for determining a signal pitch using the apparatus for determining a correlation coefficient between signals shown in FIG. 3, according to an exemplary, non-limiting embodiment of the present invention;

FIG. 7 is a flowchart illustrating an embodiment of a method for determining a correlation coefficient between signals, performed by the apparatus for determining a correlation coefficient between signals shown in FIG. 3, according to an exemplary, non-limiting embodiment of the present invention;

FIG. 8 is a flowchart illustrating an embodiment of a method for determining a correlation coefficient between signals, performed by the apparatus for determining a correlation coefficient between signals according to an exemplary, non-limiting embodiment of the present invention; and

FIG. 9 is a flowchart illustrating an embodiment of a method for determining a signal pitch, performed by the apparatus for determining a signal pitch shown in FIG. 6, according to an exemplary, non-limiting embodiment of the present invention.

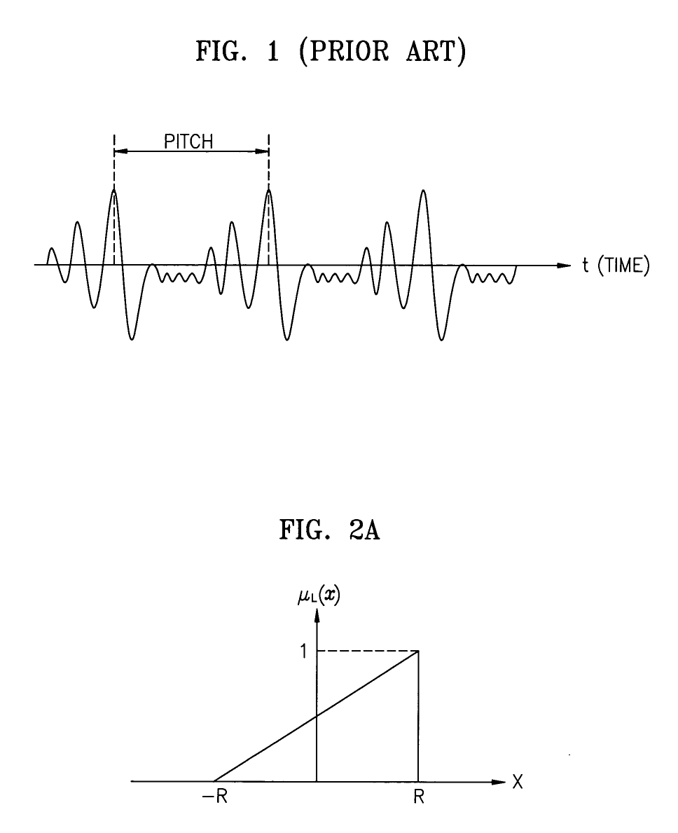

### DESCRIPTION OF THE PREFERRED EMBODIMENTS

Hereinafter, preferred, exemplary and non-limiting embodiments of the present invention will be described in detail with reference to the accompanying drawings.

First, fuzzy logic is a “concept of degree” indicating a degree of truth.

That is, the fuzzy logic is a concept that overcomes the limit of binary (0 or 1) Boolean logic indicating “truth” or “false” on which the modem computer is based. For example, but not by way of limitation, when ‘tall’ and ‘short’ are expressed as 1 or 0, “a little”, “properly”, or “very tall” may be expressed as about 0.2, or 0.5, or 0.8 of tallness. Here, 0.2, 0.5, etc., are referred to as membership grades. When a set of “tall people” is assumed to be a set A, the set A becomes a fuzzy set. Also, it is assumed that a function for determining a degree of tallness is Tall(x), and the function may be obtained by Equation 1.

$$Tall ( x ) = \{ 0 , if height ( x ) < 5 ft . , ( height ( x ) - 5 ft . ) / 2 ft . , if 5 ft . <= height ( x ) <= 7 ft . , 1 , if height ( x ) > 7 ft . \} \qquad ( 1 )$$

In this case, the function Tall(x) is referred to as a membership function of the fuzzy set A. By using the function Tall(x) defined as described above, “Tallness” may be expressed as follows. That is, when a person A is 3 feet 5 inches tall, the person A's “tallness” is “0”, when a person B is 6 feet 1 inch tall, the person B's “tallness” is “0.54”, and when a person C is 7 feet 2 inches tall, the person C's “tallness” is “1”.

Meanwhile, in the fuzzy logic, a truth condition is represented as truth (not x)=1.0−truth (x), truth (x and y)=minimum (truth(x), truth(y)), truth (x or y)=maximum (truth(x), truth(y)). Here, “truth(x)” is a probability that x is true, or a membership function of a fuzzy set.

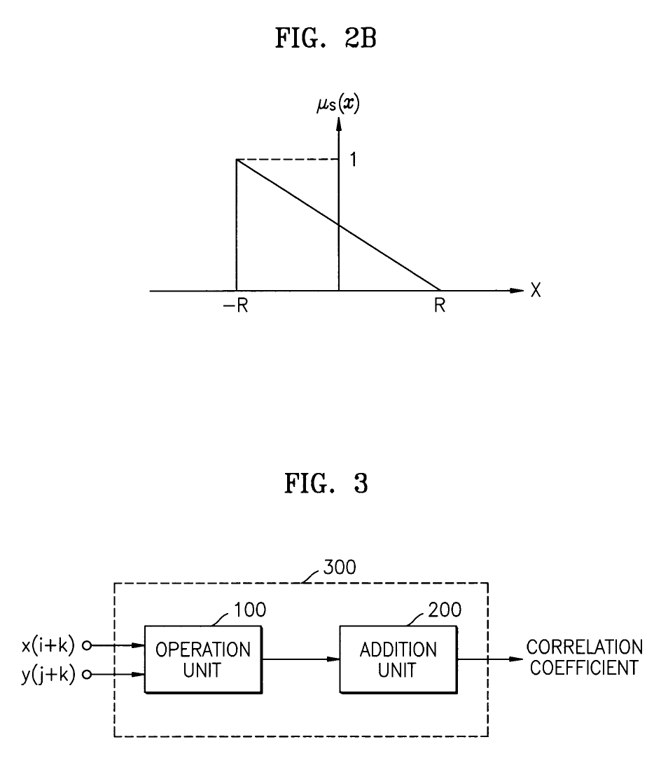

An apparatus for determining a correlation coefficient between signals using the above-mentioned fuzzy logic according to the present invention is illustrated in FIGS. 2A through 5.

In the present embodiment, first, a correlation coefficient indicating a degree of similarity between two signals is referred to as a “probability that both signals have large or small values”.

When sampled signals x[i] and y[j] have values varying from −R to R, a fuzzy set of a signal having a large value is assumed to be a set L, and a fuzzy set of a signal having a small value is assumed to be a set S.

Membership functions of the sets L and S are assumed to be μ_{L} and μₛ, respectively. Here, i and j are variables indicating the order of samples on a time axis. FIG. 2A shows the membership function μ_{L}, and FIG. 2B shows the membership function μₛ, and each of these functions μ_{L} and μₛ may be obtained by Equations 2 and 3.

μ_{L}(x)=(x+R)/2R

μₛ(x)=(−x+R)/2R (2)

The definition of the above-mentioned correlation coefficient may be expressed by Equation 3, which is a logic equation including sets L and S.

(L₁∩L_{y})∪(Sₓ∩S_{y}) (3)

Equation 3 may be expressed by Equation 4, which is a fuzzy logic equation.

max[min(μ_{L}(x), μL(y)), min(μₛ(x), μₛ(y)] (4)

When Equation 4 is interpreted according to the fuzzy logic, min(μ_{L}(x), μ_{L}(y)) indicates a probability that all of the signals x[i] and y[j] have large values, and min(μₛ(x), μₛ(y)) indicates a probability that all of the signals x[i] and y[j] have small values. Also, values shown in Equation 4 indicates a probability that all of the signals x[i] and y[j] have large or small values.

When there are M samples of a signal x and M samples of a signal y, the correlation coefficient between the signals x[i] and y[j] may be obtained by Equation 5 by using Equations 2 and 4.

$${C}_{fussy} ( x [ i ] , y [ j ] , M ) = \frac{1}{2} + \frac{1}{2 MR} {\sum }_{k = 0}^{M - 1} max [ min ( x [ i + k ] , y [ j + k ] ) , min ( - x [ i + k ] , - y [ j + k ] ) \qquad ( 5 )$$

Since an exact value of the correlation coefficient is not needed, the correlation coefficient is determined by Equation 6.

$${C}_{fussy} ( x [ i ] , y [ j ] , M ) = {\sum }_{k = 0}^{M - 1} max [ min ( x [ i + k ] , y [ j + k ] ) , min ( - x [ i + k ] , - y [ j + k ] ) \qquad ( 6 )$$

As apparent from Equation 6, the computation of the correlation coefficient requires only operations for obtaining the maximum and minimum values of input signals and addition operations, and does not require multiplication operations. Thus, the required computation is reduced, and the correlation coefficient can be quickly obtained.

Also, when x is a speech signal, a correlation coefficient between a sample signal x[i] and a sample signal x[i−L], may be obtained by Equation 7.

$${C}_{fussy} ( x [ i ] , x [ i - L ] , M ) = {\sum }_{k = 0}^{M - 1} max [ min ( x [ i + k ] , x [ i - L + k ] ) , min ( - x [ i + k ] , - x [ i - L + k ] ) \qquad ( 7 )$$

Also, a pitch of the speech signal x may be obtained by Equation 7. That is, in Equation 7, L is varied in a predetermined range, and a correlation coefficient is obtained according to each of values L, and a value L in which the correlation coefficient is maximum becomes a pitch of the speech signal. The variation range of L may be, for example, but not by way of limitation, when a sampling rate of a signal x is about 8000 sample/second, from about 20 to about 147 samples.

FIG. 3 is a block diagram illustrating an exemplary, non-limiting embodiment of an apparatus for determining a correlation coefficient between signals according to the present invention. The apparatus for determining a correlation coefficient between signals includes an operation unit 100 and an addition unit 200.

The operation unit 100 receives signals x[i], x[i+1], . . . , x[i+M−1], and signals y[j], y[j+1], . . . , and y[j+M−1], which are sampled at a predetermined sampling rate.

The operation unit 100 operates as follows.

1. Each of the signals x[i] and y[j] is applied to a first membership function μ_{L}, which is a membership function of a first fuzzy set having a large value. A minimum value therebetween is obtained, and a probability (P1) that all of the signals x[i+k] and y[j+k] have large values is determined. For example, but not by way of limitation, a function as shown in FIG. 2A, or functions having other shapes may be used as the first membership function μ_{L}.

When the first membership function μ_{L} is the function shown in FIG. 2A, the probability P1 becomes a minimum value between the signals x[i] and y[j].

2. Each of the signals x[i] and y[j] is applied to a second membership function μs, which is a membership function of a second fuzzy set having a small value. A minimum value therebetween is obtained, and a probability (P2) that all of the signals x[i] and y[i] have small values is determined. For example, a function as shown in FIG. 2B, or functions having other shapes, may be used as the second membership function μₛ.

When the second membership function μₛ is the function shown in FIG. 2B, the probability P2 becomes a minimum value between the signals −x[i] and −y[j].

3. The operation unit 100 obtains a maximum value between the probability P1 and P2, determines a probability P3 that all of the two signals x[i] and y[j] have large or small values, and outputs the result of determination to the addition unit 200.

4. The operation unit 100 performs the above procedures for each of signals x[i+1] and y[j+1] through x[i+M−1] and y[j+M−1], determines all of M probabilities P3, and outputs the respective results of determination to the addition unit 200.

The addition unit 200 adds the M probabilities P3 that are input from the operation unit 100, and determines a correlation coefficient indicating a degree of similarity between the two signals x and y.

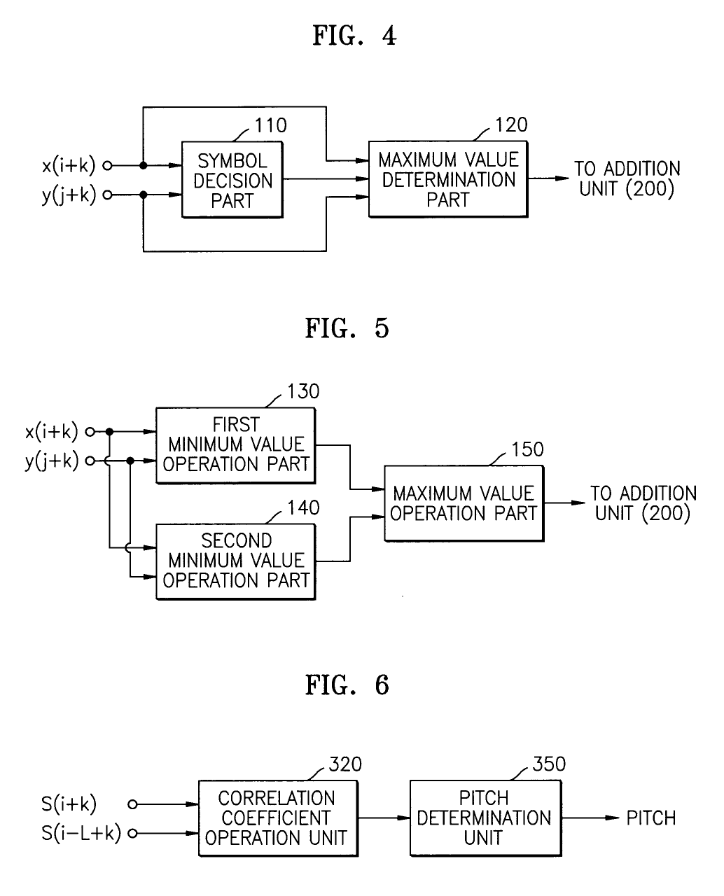

FIG. 4 is a block diagram illustrating an example of the operation unit 100 shown in FIG. 3. The operation unit 100 includes a symbol decision part 110 and a maximum value determination part 120.

Meanwhile, the terms in Equation 6 for determining the probability P3 may be obtained using the following Table 1.

TABLE 1

| X[i + k] | y[j + k] | P3 |
|---|---|---|
| + | + | min(x[i + k], y[i + k]) |
| − | − | min(−x[i + k], −y[j + k]) |
| + | − | −min(x[i + k], −y[j + k]) |
| − | + | −min(−x[i + k], y[j + k]) |

Accordingly, the operation unit 100 for determining the probability P3 may be set to operate using Equation 6 based on Table 1, as shown in FIG. 4. The symbol decision part 110 decides symbols of the signals x[i+k] and y[j+k] and outputs symbol information.

The maximum value determination part 120 receives the symbol information of the two signals x[i+k] and y[j+k] from the symbol decision part 110, and obtains the probability P3 according to Table 1.

FIG. 5 is a block diagram illustrating an example of an operation unit shown in FIG. 3. The operation unit 100 includes a first minimum value operation part 130, a second minimum value operation part 140, and a maximum value operation part 150.

The first minimum value operation part 130 receives signals x[i+k] and y[j+k], determines a minimum value between the signals x[i+k] and y[j+k], and outputs the result of determination.

The second minimum value operation part 140 receives the signals x[i+k] and y[j+k], determines a minimum value between values obtained by adding a negative number to each of the signals x[i+k] and y[j+k], and outputs the result of determination.

The maximum value operation part 150 receives a value output from the first minimum value operation part 130 and a value output from the second minimum value operation part 140, determines a maximum value therebetween, and accordingly, determines the probability P3.

FIG. 6 is a block diagram illustrating an embodiment of an apparatus for determining a signal pitch using the apparatus for determining a correlation coefficient between signals shown in FIG. 3, according to an exemplary, non-limiting embodiment of the present invention. The apparatus for determining a signal pitch includes a correlation coefficient operation unit 320 and a pitch determination unit 350.

First, the correlation coefficient operation unit 320 includes the operation unit 100 and the addition unit 200, as shown in FIG. 3, and an embodiment of the operation unit 100 is shown in FIGS. 4 and 5, as described previously.

The correlation coefficient operation unit 300 outputs one correlation coefficient, as shown in FIG. 3. However, there is a difference between the correlation coefficient operation unit 300 of FIG. 3 and the correlation coefficient operation unit 320 of FIG. 6, in that the correlation coefficient operation unit 320 of FIG. 6 operates and outputs a plurality of correlation coefficients to obtain a pitch of a signal s.

That is, the correlation coefficient operation unit 320 receives a sampled signal s[i+k] and a signal s[i−L+k] (where, k is an integer from 0 to M−1) corresponding to a signal before a sample L of the signal s[i+k], performs the above-mentioned operation, and determines one correlation coefficient.

Next, the correlation coefficient operation unit 320 receives a set of sampled signals having the varied value of the sample L. For example, but not by way of limitation, when the former signals are s[i+k] and s[i−50+k] (where, k is an integer from 0 to M−1) and the sample L is increased by 1, current signals becomes s[i+k] and s[i−51+k] (where, k is an integer from 0 to M−1). The correlation coefficient operation unit 320 determines a correlation coefficient for new signals s[i+k] and s[i−L+k].

In this way, as the value of the sample L is varied in a predetermined range, a correlation coefficient for each of the values of the sample L is determined, and a plurality of correlation coefficients are output to the pitch determination unit 350. To obtain a plurality of correlation coefficients, PitchMax+M samples of signals s[−PitchMax], s[−PitchMax+1], . . . , and s[M−1] should be prepared as an input sampled signal of the correlation coefficient operation unit 320. Here, PitchMax corresponds to a maximum value of the sample L when the sample L has a range from PitchMin to PitchMax. When a sampling rate is about 8000 samples/second, preferably, PitchMin may be about 20 samples, and PitchMax may be about 147 samples, and a signal section M for determining a correlation coefficient and/or seeking a pitch may be about 120 samples.

The pitch determination unit 350 determines a maximum value among the plurality of correlation coefficients input from the correlation coefficient operation unit 320, and determines a value of L that maximizes the value of the correlation coefficient, as a pitch of the signal s.

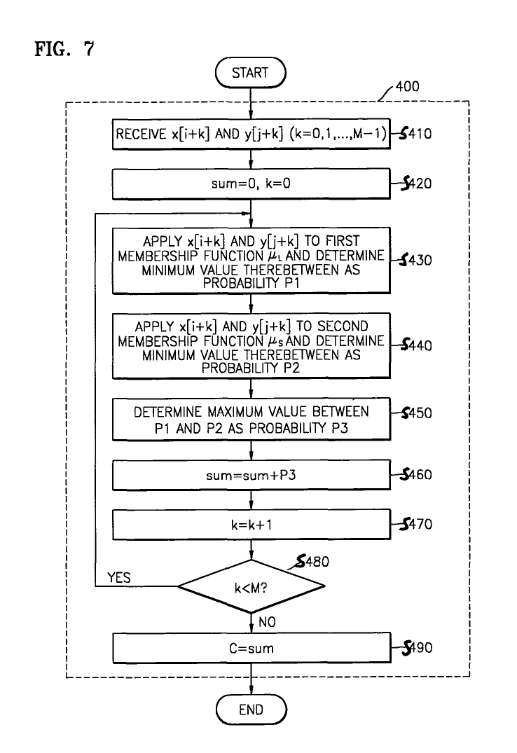

FIG. 7 is a flowchart illustrating an exemplary, non-limiting embodiment of a method 400 for determining a correlation coefficient between signals, performed by the apparatus for determining a correlation coefficient between signals shown in FIG. 3, according to the present invention. In step S410, the operation unit 100 receives samples signals x[i+k] and y[j+k] (where k is an integer from 0 to M−1).

In step S420, a variable sum at the addition unit 200 and a variable k at the operation unit 100 are set to 0. In step S430, each of the signals x[i+k] and y[j+k] is applied to a first membership function μ_{L}, which is a membership function of a first fuzzy set having a large value. A minimum value therebetween is determined as a probability (P1) that all of the signals x[i+k] and y[j+k] have large values.

In step S440, each of the signals x[i+k] and y[j+k] is applied to a second membership function μₛ, which is a membership function of a second fuzzy set having a small value. A minimum value therebetween is determined as a probability (P2) that all of the signals x[i+k] and y[i+k] have small values.

In step S450, the operation unit 100 determines a maximum value between the probability P1 and the probability P2 as a probability P3 that all of the two signals x[i+k] and y[i+k] have large values or small values.

After step S450, in step S460, the addition unit 200 receives the probability P3 obtained in step S450 by the operation unit 100 and obtains a new variable sum by adding the variable sum to the probability P3.

In step S470, the operation unit 100 increases a variable k by 1. In step S480, the operation unit 100 decides whether the variable k is smaller than M. If the variable k is smaller than M, the method returns to step S430 and repeats to steps S430 through S480 until the variable k is not smaller than M.

In step S490, if the variable k is not smaller than M, the addition unit 200 determines the value of the variable sum as the value of a correlation coefficient C.

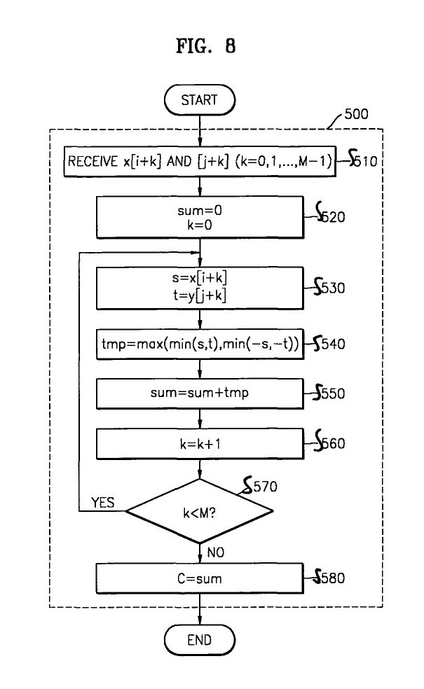

FIG. 8 is a flowchart illustrating an embodiment of a method 500 for determining a correlation coefficient between signals, performed by the apparatus for determining a correlation coefficient between signals according to an exemplary, non-limiting embodiment of the present invention.

In step S510, the operation unit 100 receives samples signals x[i+k] and y[j+k] (where k is an integer from 0 to M−1). In step S520, a variable sum at the addition unit 200 and a variable k at the operation unit 100 are set to 0.

In step S530, the operation unit 100 sets the signal x[i+k] to a variable s, and sets the signal y[j+k] to a variable t. In step S540, the operation unit 100 operates max(min(s,t),min(−s,−t)), and sets the value thereof to a variable tmp. The operation for operating the variable tmp is different from the operations of the operation unit of FIGS. 4 and 5, and the operation is as described above.

After step S540, in step S550, the addition unit 200 receives the variable tmp obtained in step S540 by the operation unit 100, and obtains a new variable sum by adding the variable sum to the variable tmp.

In step S560, the operation unit 100 increases a variable k by 1. In step S570, the operation unit 100 decides whether the variable k is smaller than M. If the variable k is smaller than M, the method 500 returns to step S530 and repeats steps S530 through S570 until the variable k is not smaller than M.

In step S580, if the variable k is not smaller than M, the addition unit 200 determines the value of the variable sum as the value of a correlation coefficient C.

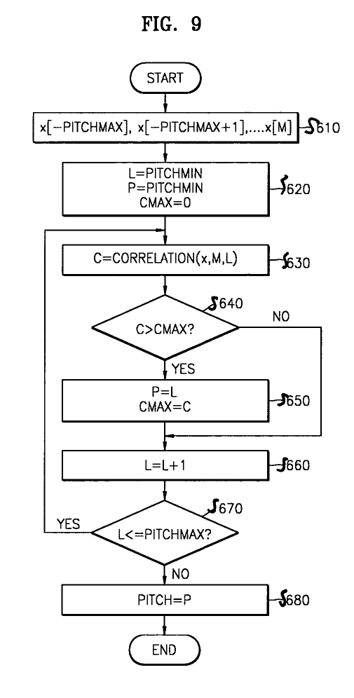

FIG. 9 is a flowchart illustrating an embodiment of a method for determining a signal pitch, performed by the apparatus for determining a signal pitch shown in FIG. 6, according to an exemplary, non-limiting embodiment of the present invention.

In step S610, the correlation coefficient determination unit 320 receives a set of samples signals x[−PitchMax], x[−PitchMax+1], . . . , and x[M−1] of a signal x.

In step S620, the correlation coefficient determination unit 320 sets a variable L indicating a seek range for PitchMin, and the pitch determination unit 350 sets a variable P indicating a pitch for PitchMin, and sets a variable Cmax indicating a correlation coefficient which is a maximum value between correlation coefficients, to 0.

In step S630, the correlation coefficient determination unit 320 calculates the correlation coefficient C by using variables x, M, and L. The calculation of the correlation coefficient C is as described with reference to FIGS. 7 and 8.

In step S640, the pitch determination unit 350 decides whether the variable C indicating a correlation coefficient obtained in step S630 is greater than CMax. When the variable C is greater than CMax, the variable P is set to the value of the variable L, and the variable CMax is set to the variable C in step S650.

In step S660, when the variable C is not greater than CMax, the correlation coefficient determination unit 320 increases the variable L by 1. In step S670, the correlation coefficient determination unit 320 decides whether the variable L is smaller than or the same as PitchMax.

When the variable L is smaller than or the same as PitchMax, the method returns to step S630 and repeats steps S630 through S670 until the variable L is greater than PitchMax.

In step S680, if the variable L is greater than PitchMax, the pitch determination unit 350 determines the value of the variable P as the value of a pitch of the signal x.

The present invention may be embodied in a code, which can be read by a computer, on a computer readable recording medium. The computer readable recording medium includes all kinds of recording apparatuses on which computer readable data are stored.

The computer readable recording media includes (but is not limited to) storage media such as magnetic storage media (e.g., ROM's, floppy disks, hard disks, etc.), optically readable media (e.g., CD-ROMs, DVDs, etc.) and carrier waves (e.g., transmissions over the Internet). Also, the computer readable recording media can be scattered on computer systems connected through a network and can be stored and executed as a computer readable code in a distributed mode.

The present invention has various advantages. For example, but not by way of limitation, as described above, the apparatus and method for determining a correlation coefficient between signals and the apparatus and method for determining a signal pitch therefor according to the present invention, by obtaining a correlation coefficient indicating a degree of similarity between two signals using fuzzy logic and by obtaining a signal pitch having the characteristic in which a similar signal is repeated, increases the computational speed and the accuracy of computation, simplifies the structure of the apparatus, and reduces power consumption.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method for determining a signal pitch, comprising:
(a) applying a first signal x[i+k] and a second signal x[i−L+k] where k is an integer from 0 to M−1, corresponding to a signal before a sample L of the first signal x[i+k] to a first membership function μ_{L} that is a membership function of a first fuzzy set including large values, obtaining a minimum value therebetween, and obtaining a probability (P1) that the first signal x[i+k] and the second signal x[i−L+k] have large values for 0<=k<=(M−1);
(b) applying the first signal x[i+k] and the second signal x[i−L+k] to a second membership function μₛ, which is a membership function of a second fuzzy set including small values, obtaining a minimum value therebetween, and obtaining a probability (P2) that the first signal x[i+k] and the second signal x[i−L+k] have small values for 0<=k<=(M−1);
(c) obtaining a maximum value between the probability P1 and the probability (P2), and generating a probability (P3) that the first signal x[i+k] and the second signal x[i−L+k] have the large values or the small values;
(d) increasing said k in units of integers from 0 to M−1, repeating (a) through (c), and obtaining M said probabilities P3;
(e) obtaining a correlation coefficient indicating a degree of similarity between the first signal x[i+k] and the second signal x[i−L+k] by adding said M said probabilities P3;
(f) varying said sample L in a range, and repeating (a) through (e); and
(g) determining said sample L corresponding to a maximum value among a plurality of said correlation coefficients obtained in (e) as a pitch of the first signal x[i+k].

2. The method of claim 1, wherein the first membership function is represented by μ_{L}(w)=(w+R)/2R, and the second membership function μₛ(w)=(−w+R)/2R where R is a positive real number, and −R<=w<=R), and (a) and (b) are performed using the first membership function and the second membership function, such that a minimum value between the first signal x[i+k] and the second signal x[i−L+k] is determined as the probability P1, and a minimum value between −x[i+k] and −x[i−L+k] obtained by adding a negative symbol to the first signal x[i+k] and the second signal x[i−L+k] for 0<=k<=(M−1) is determined as the probability P2.

3. A method for determining a signal pitch, comprising:
(a) applying a first signal x[i+k] and a second signal x[i−L+k] for a sample L to the following equation and obtaining a probability P3 that the first signal x[i+k] and the second signal x[i−L+k] have large values or small values:
max[min(μ_{L}(x[i+k]), μ_{L}(x[i−L+k])), min(μₛ(x[i+k], μₛ(x[i−L+k]))],
where k is an integer from 0 to M−1, said μ_{L} is a first membership function that is a membership function of a first fuzzy set having said large values, and said μₛ is a second membership function that is a membership function of a second fuzzy set having said small values;
(b) increasing said k in units of integers from 0 to M−1, repeating (a), and obtaining M said probabilities P3;
(c) obtaining a correlation coefficient indicating a degree of similarity between the first signal x[i+k] and the second signal x[i−L+k] by adding said M probabilities P3;
(d) varying said sample L in a predetermined range and repeating (a) through (c); and
(e) determining said sample L corresponding to a maximum value among a plurality of correlation coefficients obtained in (c) as a pitch of the first signal x[i+k].

4. The method of claim 3, wherein the first membership function is represented by μ_{L}(w)=(w+R)/2R, and the second membership function is represented by μₛ(w)=(−w+R)/2R, and by applying the first membership function and the second membership function to the above equation in (a), the probability P3 is obtained by the following equation:
max[min(x[i+k]), x[i−L+k]), min(−x[i+k], −x[i−L+k])].

5. The method of claim 4, wherein (a) comprises:
(a1) deciding a corresponding symbol for each of the first signal x[i+k] and the second signal x[i−L+k]; and
(a2) receiving symbol information of the first signal x[i+k] and the second signal x[i−L+k] and obtaining the probability P3 according to the following table:

| X[I + k] | x[i − L + k] | P3 |
|---|---|---|
| + | + | min(x[i + k], x[i − L + k]) |
| − | − | min(−x[I + k], −x[i − L + k]) |
| + | − | −min(x[I + k], −x[i − L + k]) |
| − | + | −min(−x[I + k], x[i − L + k]) |

6. The method of claim 4, wherein (a) comprises:
(a1) obtaining a minimum value between the first signal x[i+k] and the second signal x[i−L+k];
(a2) obtaining a minimum value between values obtained by adding a negative symbol to each of the first signal x[i+k] and the second signal x[i−L+k]; and
(a3) obtaining a maximum value between the minimum value obtained in (a1) and the minimum value obtained in (a2), and obtaining the probability P3.

7. A method for determining a correlation coefficient between signals, the method comprising:
(a) applying a first signal x[i+k] and a second signal y[j+k], where k is an integer from 0 to M−1, to a first membership function μ_{L} of a first fuzzy set having large values, obtaining a minimum value therebetween, and obtaining a probability P1 that the first signal x[i+k] and the second signal y[j+k] have said large values for 0<=k<=(M−1);
(b) applying the first signal x[i+k] and the second signal y[j+k] to a second membership function μₛ of a second fuzzy set having small values, obtaining a minimum value therebetween, and obtaining a probability P2 that the first signal x[i+k] and the second signal y[j+k] have the small values for 0<=k<=(M−1);
(c) obtaining a maximum value between the probability P1 and the probability P2 and obtaining a probability P3 that the first signal x[i+k] and the second signal y[j+k] have the large values or the small values;
(d) increasing said k in units of integers from 0 to M−1, repeating (a) through (c), and obtaining M probabilities P3; and
(e) obtaining a correlation coefficient indicating a degree of similarity between the first signal x[i+k] and the second signal y[j+k] by adding said M probabilities P3 for 0<=k<=(M−1).

8. The method of claim 7, wherein the first membership function is represented by μ_{L}(w)=(w+R)/2R, and the second membership function is represented by μₛ(w)=(−w+R)/2R, where R is a positive real number, and −R<=w<=R, and (a) and (b) are performed using the first membership function and the second membership function such that a minimum value between the first signal x[i+k] and the second signal y[j+k] is determined as the probability P1 and a minimum value between −x[i+k] and −y[j+k] obtained by adding a negative symbol to each of the first signal x[i+k] and the second signal y[j+k] is determined as the probability P2 for 0<=k<=(M−1).

9. A method for determining a correlation coefficient between signals, comprising:
(a) applying a first signal x[i+k] and a second signal y[j+k] to the following equation and obtaining a probability P3 that the first signal x[i+k] and the second signal y[j+k] have large values or small values:
max[min(μ_{L}(x[i+k]), μ_{L}(y[j+k])), min(μₛ(x[i+k], μₛ(y[j+k]))],
where k is an integer from 0 to M−1, said μ_{L} is a first membership function that is a membership function of a first fuzzy set having said large values, and said μₛ is a second membership function that is a membership function of a second fuzzy set having said small values;
(b) increasing said k in units of integers from 0 to M−1, repeating (a), and obtaining M probabilities P3; and
(c) obtaining a correlation coefficient indicating a degree of similarity between the first signal x[i+k] and the second signal y[j+k] by adding said M probabilities P3.

10. The method of claim 9, wherein the first membership function is represented by μ_{L}(w)=(w+R)/2R, and the second membership function is represented by μₛ(w)=(−w+R)/2R, and by applying the first membership function and the second membership function to the above equation in (a), the probability P3 is obtained by the following equation:
max[min(x[i+k]), y[j+k]), min(−x[i+k], −y[j+k])].

11. The method of claim 10, wherein (a) comprises:
(a1) deciding symbols of the first signal x[i+k] and the second signal y[j+k]; and
(a2) receiving symbol information of the first signal x[i+k] and the second signal y[j+k]and obtaining the probability P3 according to the following table:

| x[i + k] | y[j + k] | P3 |
|---|---|---|
| + | + | min(x[i + k], y[j + k]) |
| − | − | min(−x[i + k], −y[j + k]) |
| + | − | −min(x[i + k], −y[j + k]) |
| − | + | −min(−x[i + k], y[j + k]) |

12. The method of claim 10, wherein (a) comprises:
(a1) obtaining a minimum value between the first signal x[i+k] and the second signal y[j+k];
(a2) obtaining a minimum value between values obtained by adding a negative symbol to each of the first signal x[i+k] and the second signal y[j+k]; and
(a3) obtaining a maximum value between the value obtained in (a1) and the value obtained in (a2) and obtaining the probability P3.

13. An apparatus for determining a signal pitch, comprising:
an operation unit which receives a first signal x[i+k] and a second signal x[i−L+k] where k is an integer from 0 to M−1, said second signal x[i−L+k] corresponding to a signal before a sample L of the first signal x[i+k], applies the first signal x[i+k] and the second signal x[i−L+k] to a first membership function μ_{L} of a first fuzzy set having large values, obtains a minimum value therebetween, and obtaining a probability P1 that the first signal x[i+k] and the second signal x[i−L+k] have large values, applies the first signal x[i+k] and the second signal x[i−L+k] to a second membership function μₛ of a second fuzzy set having small values, obtains a minimum value therebetween, obtains a probability P2 that the first signal x[i+k] and the second signal x[i−L+k] have small values, obtains a maximum value between the probability P1 and the probability P2, obtains a probability P3 that the first signal x[i+k] and the second signal x[i−L+k] have the large values or the small values, increases said k in units of integers from 0 to M−1, repeats the above operations on a pair of the first signal x[i+k] and the second signal x[i−L+k] corresponding to said k, and obtains M probabilities P3;
an addition unit that obtains a correlation coefficient indicating a degree of similarity between the first signal x[i+k] and the second signal x[i−L+k] by adding said M probabilities P3;
wherein as said sample L is varied in a range, the operation unit determines the probabilities P3 for each value of the sample L and outputs a result of said determination to the addition unit, and the addition unit determines a correlation coefficient by adding said M probabilities P3 for each value of the sample L and outputs a plurality of correlation coefficients; and
a pitch determination unit that determines the sample L corresponding to a maximum value among the plurality of correlation coefficients input from the addition unit as a pitch of the first signal x[i+k].

14. The apparatus of claim 13, wherein the first membership function is represented as μ_{L}(w)=(w+R)/2R, and the second membership function is represented as μs(w)=(−w+R)/2R, where R is a positive real number, and −R<=w<=R, and the operation unit performs an operation for obtaining the probability P1 and the probability P2 using the first membership function and the second membership function, such that a minimum value between the first signal x[i+k] and the second signal x[i−L+k] is determined as the probability P1 and a minimum value between −x[i+k] and −x[i−L+k], obtained by adding a negative symbol to each of the first signal x[i+k] and the second signal x[i−L+k], is determined as the probability P2 for 0<=k<=(M−1).

15. An apparatus for determining a signal pitch, comprising:
an operation unit which receives a first signal x[i+k] and a second signal x[i−L+k] where k is an integer from 0 to M−1, said second signal x[i−L+k] corresponding to a signal before a sample L of the first signal x[i+k], applies the first signal x[i+k] and the second signal x[i−L+k] to the following equation:
max[min(μ_{L}(x[i+k]), μ_{L}(x[i−L+k])), min(μₛ(x[i+k], μₛ(x[i−L+k]))]
where said μ_{L} is a first membership function of a first fuzzy set having large values, and said μₛ is a second membership function of a second fuzzy set having small values,
wherein said operation unit obtains a probability P3 that all of the first signal x[i+k] and the second signal x[i−L+k] have the large values or the small values, increases said k in units of integers from 0 to M−1, repeats the above operations on a pair of the first signal x[i+k] and the second signal x[i−L+k] corresponding to said k, and obtains M probabilities P3;
an addition unit that obtains a correlation coefficient indicating a degree of similarity between the first signal x[i+k] and the second signal x[i−L+k] by adding said M probabilities P3 input from the operation unit;
wherein as said sample L is varied in a predetermined range, the operation unit determines the probabilities P3 for each value of the sample L and outputs the result of said determination to the addition unit, and the addition unit determines a correlation coefficient by adding said M probabilities P3 for each value of the sample L and outputs a plurality of correlation coefficients; and
a pitch determination unit which determines the sample L corresponding to a maximum value among the plurality of correlation coefficients input from the addition unit as a pitch of the first signal x[i+k].

16. The apparatus of claim 15, wherein the first membership function is represented by μ_{L}(w)=(w+R)/2R, and the second membership function is represented by μₛ(w)=(−w+R)/2R, and the operation unit obtains the probability P3 by the following equation using the first membership function and the second membership function:
max[min(x[i+k]), x[i−L+k]), min(−x[i+k], −x[i−L+k])].

17. The apparatus of claim 16, wherein the operation unit comprises:
a symbol decision unit that decides symbols of the first signal x[i+k] and the second signal x[i−L+k]; and
a maximum value determination unit that receives symbol information of the first signal x[i+k] and the second signal x[i−L+k] and obtains the probability P3 according to the following table:

| x[i + k] | x[i − L + k] | P3 |
|---|---|---|
| + | + | min(x[I + k], x[i − L + k]) |
| − | − | min(−x[I + k], −x[i − L + k]) |
| + | − | −min(x[I + k], −x[i − L + k]) |
| − | + | −min(−x[I + k], x[i − L + k]) |

18. The apparatus of claim 16, wherein the operation unit comprises:
a first minimum value operation unit that receives the first signal x[i+k] and the second signal x[i−L+k], obtains a minimum value therebetween, and outputs the minimum value;
a second minimum value operation unit that receives the first signal x[i+k] and the second signal x[i−L+k], obtains a minimum value between values obtained by adding a negative symbol to each of the first signal x[i+k] and the second signal x[i−L+k], and outputs the minimum value; and
a maximum value operation unit that receives a value output from the first minimum value operation unit and a value output from the second minimum value operation unit, obtains a maximum value therebetween, and obtains the probability P3.

19. An apparatus for determining a correlation coefficient between signals, comprising:
an operation unit that receives a first signal x[i+k] and a second signal y[j+k], where k is an integer from 0 to M−1, applies the first signal x[i+k] and the second signal y[j+k] to a first membership function μ_{L} of a first fuzzy set having large values, obtains a minimum value therebetween, obtains a probability P1 that the first signal x[i+k] and the second signal y[j+k] have large values, applies the first signal x[i+k] and the second signal y[j+k] to a second membership function μₛ of a second fuzzy set having small values, obtains a minimum value therebetween, obtains a probability P2 that the first signal x[i+k] and the second signal y[j+k] have small values, obtains a maximum value between the probability P1 and the probability P2, obtains a probability P3 that the first signal x[i+k] and the second signal y[j+k] have the large values or the small values, increases said k in units of integers from 0 to M−1, repeats the above operations on the first signal x[i+k] and the second signal y[j+k] corresponding to said k, and obtains M probabilities P3; and
an addition unit that obtains a correlation coefficient indicating a degree of similarity between the first signal x[i+k] and the second signal y[j+k] by adding said M probabilities P3 input from the operation unit.

20. The apparatus of claim 19, wherein the first membership function is represented by μ_{L}(w)=(w+R)/2R, and the second membership function is represented by μₛ(w)=(−w+R)/2R, where R is a positive real number and −R<=w<=R, and the operation unit performs an operation for obtaining the probabilities P1 and p2 using the first membership function and the second membership function such that a minimum value between the first signal x[i+k] and the second signal y[j+k] is determined as the probability P1 and a minimum value between −x[i+k] and −y[j+k] obtained by adding a negative symbol to each of the first signal x[i+k] and the second signal y[j+k] is determined as the probability P2.

21. An apparatus for determining a correlation coefficient between signals, comprising:
an operation unit which receives a first signal x[i+k] and a second signal y[j+k] where k is an integer from 0 to M−1, applies the first signal x[i+k] and the second signal y[j+k] to the following equation:
max[min(μ_{L}(x[i+k]), μ_{L}(y[j+k])), min(μₛ(x[i+k], μₛ(y[j+k]))]
where said μ_{L} is a first membership function of a first fuzzy set having large values, and said μₛ is a second membership function of a second fuzzy set having small values,
obtains a probability P3 that the first signal x[i+k] and the second signal y[j+k] have large or small values, increases said k in units of integers from 0 to M−1, repeats the above operations on a pair of the first signal x[i+k] and the second signal y[j+k] corresponding to said k, and obtains M probabilities P3; and
an addition unit that obtains a correlation coefficient indicating a degree of similarity between the first signal x[i+k] and the second signal y[j+k] by adding said M probabilities P3.

22. The apparatus of claim 21, wherein the first membership function is represented by μ_{L}(w)=(w+R)/2R, and the second membership function is represented by μₛ(w)=(−w+R)/2R, and the operation unit obtains the probability P3 by the following equation using the first membership function and the second membership function:
max[min(x[i+k]), y[j+k]), min(−x[i+k], −y[j+k])]

23. The apparatus of claim 22, wherein the operation unit comprises:
a symbol decision unit that decides symbols of the first signal x[i+k] and the second signal y[j+k]; and
a maximum value determination part which receives symbol information of the first signal x[i+k] and the second signal y[j+k] and obtains the probability P3 according to the following table:

| x[I + k] | y[j + k] | P3 |
|---|---|---|
| + | + | min(x[I + k], y[j + k]) |
| − | − | min(−x[i + k], −y[j + k]) |
| + | − | −min(x[i + k], −y[j + k]) |
| − | + | −min(−x[I + k], y[j + k]) |

24. The apparatus of claim 22, wherein the operation unit comprises:
a first minimum value operation unit which receives the first signal x[i+k] and the second signal y[j+k], obtains a minimum value therebetween, and outputs the minimum value;
a second minimum value operation unit that receives the first signal x[i+k] and the second signal y[j+k], obtains a minimum value between values obtained by adding a negative symbol to each of the first signal x[i+k] and the second signal y[j+k], and outputs a maximum value; and
a maximum value operation part which receives a value output from the first minimum value operation part and a value output from the second minimum value operation part, obtains a maximum value therebetween, and obtains the probability P3.

25. A computer readable recording medium on which a program for implementing a method for determining a signal pitch is recorded, said program having instructions comprising:
(a) applying a first signal x[i+k] and a second signal x[i−L+k], where k is an integer from 0 to M−1, the second signal x[i−L+k] corresponding to a signal before a sample L of the first signal x[i+k], to a first membership function μ_{L} of a first fuzzy set having large values, obtaining a minimum value therebetween, and obtaining a probability P1 that the first signal x[i+k] and the second signal x[i−L+k] have said large values;
(b) applying the first signal x[i+k] and the second signal x[i−L+k] to a second membership function μₛ of a second fuzzy set having small values, obtaining a minimum value therebetween, and obtaining a probability P2 that all of the first signal x[i+k] and the second signal x[i−L+k] have said small values;
(c) obtaining a maximum value between the probability P1 and the probability P2 and obtaining a probability P3 that the first signal x[i+k] and the second signal x[i−L+k] have said large values or said small values;
(d) increasing said k in units of integers from 0 to M−1, repeating (a) through (c), and obtaining M probabilities P3;
(e) obtaining a correlation coefficient indicating a degree of similarity between the first signal x[i+k] and the second signal x[i−L+k] by adding said M probabilities P3;
(f) varying said sample L in a predetermined range and repeating (a) through (e); and
(g) determining said sample L corresponding to a maximum value among a plurality of correlation coefficients obtained in (e) as a pitch of the first signal x[i+k].

26. A computer readable recording medium on which a program for implementing a method for determining a signal pitch is recorded, said program having instructions comprising:
(a) applying a first signal x[i+k] and a second signal x[i−L+k] to the following equation and obtaining a probability P3 that the first signal x[i+k] and the second signal x[i−L+k] have large values or small values:
max[min(μ_{L}(x[i+k]), μ_{L}(x[i−L+k])), min(μₛ(x[i+k], μₛ(x[i−L+k]))]
where k is an integer from 0 to M−1, said μ_{L} is a first membership function of a first fuzzy set having large values, and said μₛ is a second membership function of a second fuzzy set having small values;
(b) increasing said k in units of integers from 0 to M−1, repeating (a), and obtaining M probabilities P3;
(c) obtaining a correlation coefficient indicating a degree of similarity between the first signal x[i+k] and the second signal x[i−L+k] by adding said M probabilities P3;
(d) varying said sample L in a predetermined range and repeating (a) through (c); and
(e) determining said sample L corresponding to a maximum value among a plurality of correlation coefficients obtained in (c) as a pitch of the first signal x[i+k].

27. A computer readable recording medium on which a program for implementing a method for determining a correlation coefficient between signals is recorded, said program having instructions comprising (a) applying a first signal x[i+k] and a second signal y[j+k], where k is an integer from 0 to M−1, to a first membership function μ_{L} of a first fuzzy set having large values, obtaining a minimum value therebetween, and obtaining a probability P1 that the first signal x[i+k] and the second signal y[j+k] have said large values;
(b) applying the first signal x[i+k] and the second signal y[j+k] to a second membership function μₛ of a second fuzzy set having small values, obtaining a minimum value therebetween, and obtaining a probability P2 that the first signal x[i+k] and the second signal y[j+k] have said small values;
(c) obtaining a maximum value between the probability P1 and the probability P2 and obtaining a probability P3 that the first signal x[i+k] and the second signal y[j+k] have said large values or said small values;
(d) increasing said k in units of integers from 0 to M−1, repeating (a) through (c), and obtaining M probabilities P3; and
(e) obtaining a correlation coefficient indicating a degree of similarity between the first signal x[i+k] and the second signal y[j+k] by adding said M probabilities P3.

28. A computer readable recording medium on which a program for implementing a method for determining a correlation coefficient between signals is recorded, said program having instructions comprising:
(a) applying a first signal x[i+k] and a second signal y[j+k] to the following equation and obtaining a probability P3 that the first signal x[i+k] and the second signal y[j+k] have large values or small values:
max[min(μ_{L}(x[i+k]), μ_{L}(y[j+k])), min(μₛ(x[i+k], μₛ(y[j+k]))]
where k is an integer from 0 to M−1, said μ_{L} is a first membership function of a first fuzzy set having large values, and said μₛ is a second membership function of a second fuzzy set having small values;
(b) increasing said k in units of integers from 0 to M−1, repeating (a), and obtaining M probabilities P3; and
(c) obtaining a correlation coefficient indicating a degree of similarity between the first signal x[i+k] and the second signal y[j+k] by adding said M probabilities P3.
